(19) United States
(12) Patent Application Publication
(10) Pub. No.: US 2007/0228739 A1
(43) Pub. Date: Oct. 4, 2007

(54) Offshore Energy Capture and Storage Device

(75) Inventor: John Troy Kraczek, Farmington, UT (US)

Correspondence Address: Mr.John Troy Kraczek, 194 N. Ironside Way, Farmington, UT, 84025, US

(73) Assignee: John Troy Kraczek, Farmington, UT (US)

(21) Appl. No.: 11/308,514

(22) Filed: Mar. 31, 2006

(51) Int. Cl. F03B 13/12; F03B 13/10; H02P 9/04

(52) U.S. Cl. 290/53

(57) ABSTRACT

The Offshore Energy Capture and Storage Device, (OECS), is a free floating tank device with a mast, anchored by an angled line to the sea floor far offshore in deep water. Using wind and wave turbans the device captures wind and/or wave energy and converts it to Hydrogen, which is stored on board until it is needed on shore. The stored Hydrogen energy may then be transferred by tanker to shore and used to produce electrical power for the grid, converted to synthetic natural gas for heating, or used as a clean transportation fuel, all without pollution or greenhouse gas emissions. Many of the devices can be placed in groups far off shore in order to produce a significant supply of clean renewable energy.

### BACKGROUND OF THE INVENTION

This Invention deals with a device that captures ocean wind and/or wave energy, converts it to hydrogen, and stores it for retrieval and later use by energy markets. Initial concepts for the O.E.C.S. were conceived on Mar. 6^{th}, 2003 by John Troy Kraczek, a Mechanical Engineer and US citizen residing at 194 N. Ironside Way, Farmington, in Davis County in the State of Utah, United States of America, and since that time he has worked on improving and clarifying the device concepts and development until enough technical issues have been resolved to allow actual production and patent filing.

Fossil fuels have several disadvantages. These include the fact that they are limited, that they produce pollution when burned, and that they may contribute to global warming through greenhouse gas release as well as heat production as they are consumed.

Many Renewable Energy projects have been attempted over the last forty years. One of the more successful concepts has been the use of wind turbans to supplement electricity on the power grid. While successful, these devices and this approach has been challenged on two fronts. Environmentally they suffer from location restrictions due to view obstruction, real estate costs, low average wind speed restrictions or bird flyway endangerment. On the production side these devices also suffer from a lack of cooperation between wind and grid loads. In other words, max wind and max electrical grid needs rarely line up at the same time. While charging batteries is often used to correct this problem it is not efficient and it is costly. In addition some of the better land based wind sites are not near existing power transmission lines. Beside issues of land ownership and the problems of environmental impact on wildlife, both large hurdles to existing wind turban systems, the fact is that many land based sites simply lack the needed average wind speeds to make a significant contribution to the growing power needs.

While other wave energy capture devices have been tried and tested, most have only met with minimal success. Surface wave motion is complex and the water in the wave zone tends to move as a rolling surging group making it difficult to obtain a differential to capture energy from.

### BRIEF SUMMARY OF THE INVENTION

The Offshore Energy Capture and Storage Device overcomes several of the disadvantages of land or shore based wind turbans. First, designed to float far out at sea, the device can be positioned anywhere in vast ocean areas where it does not obstruct shore views, or endanger migratory birds or land based animals and can take advantage of significantly higher average wind speeds. It is anticipated that it will have no negative and some slightly positive effects on sea life. Second, the device creates hydrogen for use later, and stores this energy medium on board. When the energy is needed it is offloaded and tanked to shore. For electrical grid power it is simply consumed in fuel cell power plants during peak load periods and when not needed it is stored until it is. The hydrogen may also be used as transportation fuel or as a natural gas supplement as needed. Beside the advantage that the OECS device has over land-based units as a result of higher average wind speeds, the device can also capitalize on wave energy, not available to land based windmills.

The Offshore Energy Capture and Storage Device is a free-floating device, anchored by an angled line to the sea floor. It carries a wind turban or other wind capture device on a raised mast or masts, which is mounted to the floating body. The body of the device is basically a tank or vertical hull that is divided into compartments for floatation, gas storage, aqueous solution storage, ballast, operational equipment, electrical data transmission, location and storage devices.

When rigged for capturing wave energy, the OECS device uses underwater wings that are driven by the entire weight of the total device as it rides the waves. Because these wings are positioned very deep in the water, the wings are plunged through a static or laminar layer of water providing a differential between the wave surface and the stable lower water. As the device rides up and down on the waves above it drives the blades through the static layer to capture the potential energy differential.

Many of the devices can be grouped into fields or farms far out at sea.

### BRIEF DESCRIPTION OF THE SEVERAL VIEWS OF THE DRAWING

Five Figures outline the basics of the OECS device:

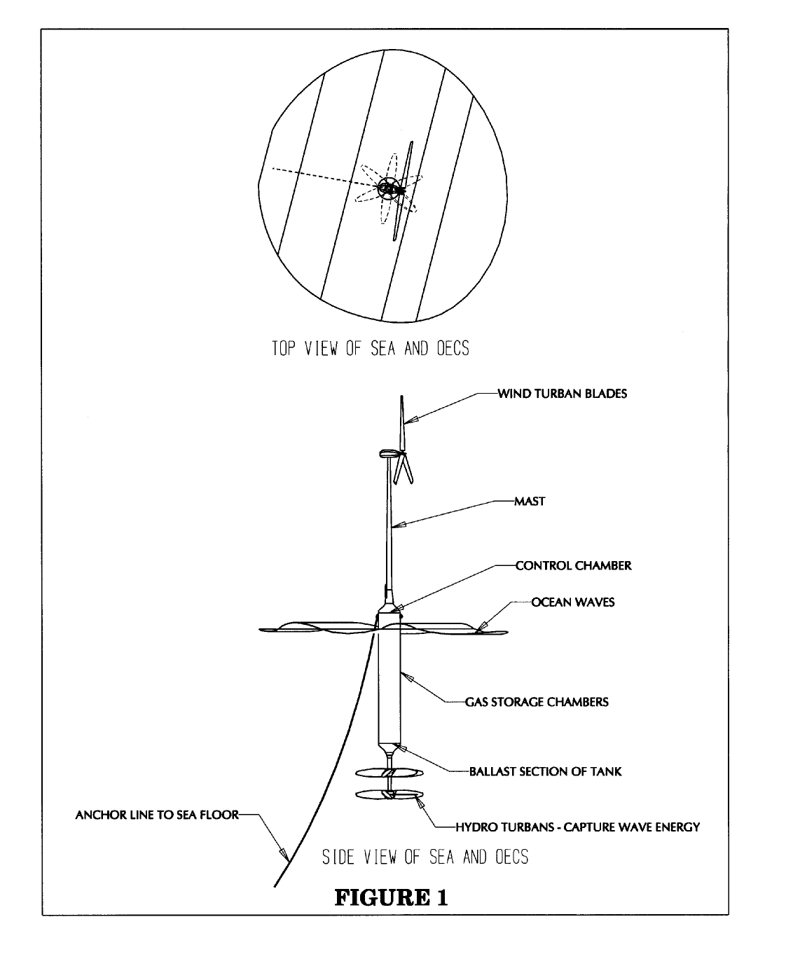

(1) FIG. 1 shows the device from the side view and top view, tethered at sea.

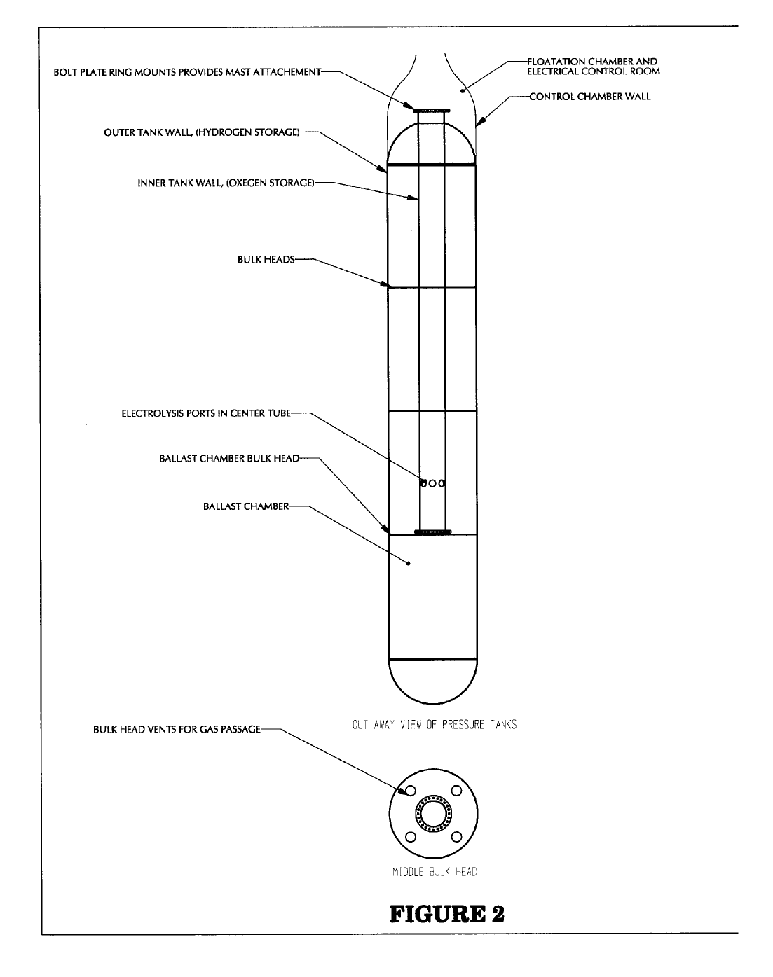

(2) FIG. 2 shows the inner and outer tank arrangements and basic proportions

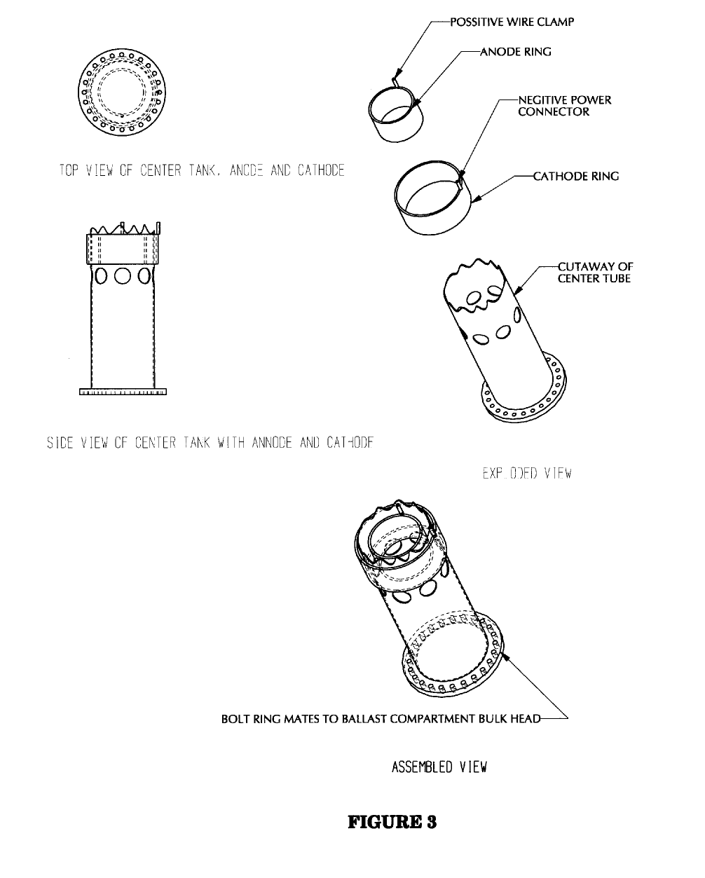

(3) FIG. 3 shows the inner Anode and Cathode positions

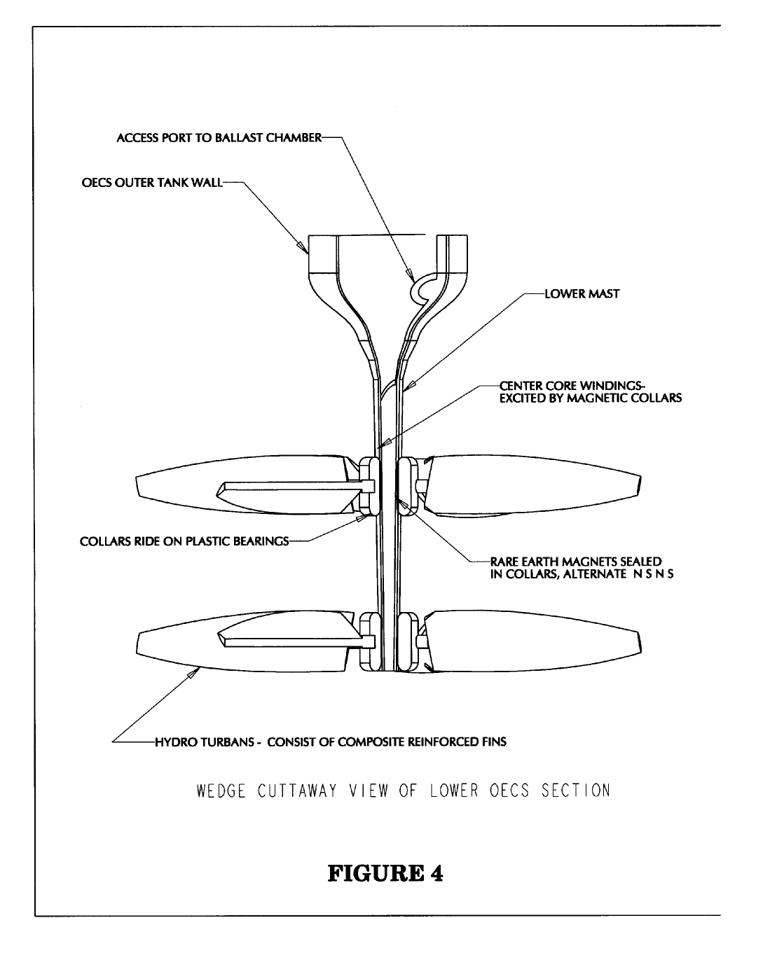

(4) FIG. 4 shows a cutaway of the wave energy capture wings and magnetic collar

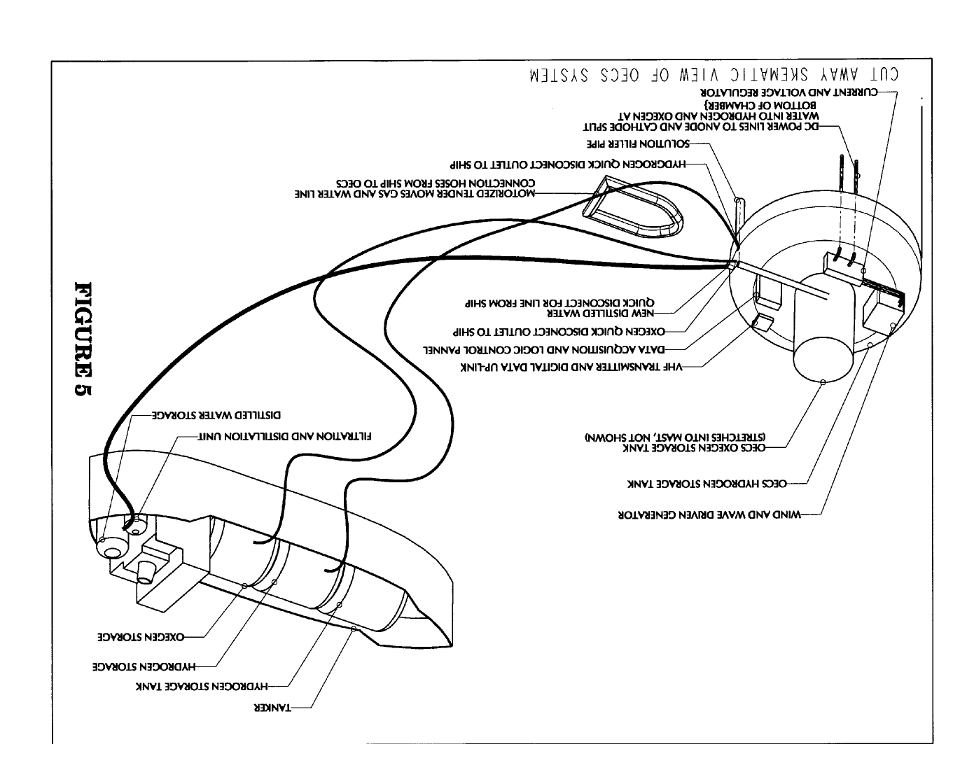

(5) FIG. 5 Shows a schematic of the system details including transfer arrangements

### DETAILED DESCRIPTION OF THE INVENTION AND OPERATION SYSTEMS

In the ideal embodiment of the O.E.C.S device, the outer tank is constructed of rolled ½″ steel plate creating a tube 9′ diameter tube by 50′ long. The seams are dual shield welded from both sides and inspected to insure good penetration, and minimal porosity. A second tube, ideally built of hydrogen resistant plastic with a 30″ diameter is positioned in the center of the larger steel tube and held in place with 6 framers or bulk heads attached to the outer and inside tanks. These framers or bulkheads have openings that allow the gas to pass the full length of the tank. The entire surface of the outer tank is electro plated inside and out to reduce corrosion and hydrogen enbrittlement. A copper base material, followed by nickel and then cadmium is recommended for the electroplate.

The end of the main tank which will become the top of the tank when installed in the water, is fitted with a tank end and four (4) 4″ couplings, two connecting the outer chamber through the tank end and the other two connecting the inside tube chamber through the tank end. Two of the 4″ pipes run the full length of the inner tank, one of the inside of the outer tank and the second on the inside of the inner tank. These lines are for adding liquid to tank and also used in purging air prior to producing hydrogen and oxygen production. The other two 4″ openings are the path by which the hydrogen and oxygen are drained from the storage tanks.

The main inside tube is sealed air tight to the tank end by welding a half coupling in place. The 30″ diameter plastic tube is then threaded into the coupling and sealed with thread dope inside.

An additional outer tank end is formed and welded onto the tank end. This extension creates a small room for onboard equipment. A sealed hatch in the top of the room allows access to the equipment in this space. The equipment consists of the following: An alternator driven by jack shaft and chain from the wind turban above; a low Watt Marine Transmitter for warning approaching shipping; a data acquisition system for monitoring production with a ship to ship data transmission unit; a pressure monitor which shuts the electrolysis system down when the tank pressures reach a preset psi, (Such as 1000 psi). The roof of this compartment also provides a bolt circle to tie the wind mast to. Power control and high speed switching circuits modify and combine the power from the wind turban alternator and the wave turban into a high amperage low voltage DC, ideally suited to drive the electrolysis at maximum efficiency. Operational batteries and a small Fuel Cell provide the power to drive the transmitters and the system equipment. Plumbing from the tanks comes through the control room “roof” where quick release fittings and values allow the hydrogen and oxygen to be drained off to the tanker.

The wind mast, which also serves as additional gas storage, is plumbed to the gas coupling in the center lower tube. The Wind Mast is made of ⅜″ steel plate, rolled conically. It is 50′ long. The top has an 18″ diameter, which widens to a 36″ base. Both ends have steel bulkheads, circular bolt plates for attachment. The mast also has an airtight chamber or conduit to transfer power from the wind turban to the control room. A platform is bolted to the circular bolt plate at the top of the mast. The platforms are designed to support a variety of 75 KW wind turban models currently available from different manufacturers or custom made models.

At the opposite end, or bottom of the device, the inside tank is held in position by a collar at the lower end. The inside tank has holes in the tank wall which provide a path for electrolysis in the aqueous solution. A sealed man hatch is also provided on this end of the tank for access to the anode and cathode when the device is pulled out for maintenance. Beyond the tank end a bolt circle ring allows the attachment of the ballast chamber. A lower bolt ring allows the attachment of the wave energy capture fin mast with its additional ballast.

The wave energy capture fin device is built using fiberglass water wings angled for maximum torque. Two counter rotating fiberglass collars are provided for the wings to attach to. These collars rotate on their shaft on plastic bearings. The collars have magnets built into them. Inside the shaft coils of wire windings are protected from the seawater by plastic electrical potting. The slow AC current generated by this arrangement is bridged to DC with diodes in the control room at the top of the tank.

The device is deployed in the open water and anchored to the sea floor. In order to clear the device of any air and contaminating gases, the device must be purged as follows. While supported by the device tender ship, the gas storage tanks are completely filled with the OECS aqueous solution, a combination of distilled water and the addition of a typical catalyst such as hydrochloric acid at two tenths of 1% solution. Pure Hydrogen and Oxygen are pumped into their respective storage tanks and some of the aqueous solution is forced back out. When the solution reaches the correct operational levels, the valves are closed and the device is buoyant at the correct starting level.

The tender ship moves away from the device and the wind turban park brake is released by remote control. As the wind spins the turban and/or the wave action begins to produce electrical energy, the device electrical control automatically adjusts the incoming electrical energy to the optimum voltage and amperage to get maximum separation of hydrogen and oxygen from the aqueous solution. In the embodiment that stores the gases as compressed gas, the hydrogen rises up through the aqueous solution in the outer chamber while the oxygen bubbles up and accumulates in the inner chamber. The gases collect above the aqueous solution and eventually compress. The electrical controller adjusts the current flow at the anode and cathode to maintain optimum split even as increasing pressure changes the equation. In an alternative embodiment, the electricity is also used to convert NaC into NaCH4 or some other hydrogen-bearing polymer, and the hydrogen is not stored as a gas, but stored as a liquid or a powder.

Approximately every four to seven days a tanker ship returns to each device. The blades are parked, and an inflatable rubber tender moves between the tanker and the OECS, pulling three hoses. These are attached to the OECS, and each has terminus with a uniquely sized quick disconnect fitting thus preventing cross over contamination. The first is the aqueous water solution transfer line. The second is the Hydrogen line, and the third is the Oxygen line. When they have been connected between ship and OECS device, the valves are opened in the device as well as on the line side. The compressed gases drain out at the same time that a metered measure of aqueous solution is pumped back in.

The tanker has several critical functions for the functioning of the system. The tanker compresses and stores the gases coming off the OECS devices in the field. On board the tanker the gases are pumped into storage tanks. In addition a desalination and distillation unit on board the tanker turns seawater into pure water, which is stored and converted to aqueous solution for refilling the OECS devices. Data on each OECS device in the field is also tracked on the tanker. When devices need maintenance either the tanker or a maintenance ship is equipped to hoist the devices out of the water for on deck repairs. In systems storing the hydrogen as NaCH4 the process of converting the NaC may occur onboard the tanker rather than on the OECS. Upon reaching shore the tanker connects lines to onshore storage tanks where it pumps the compressed gases or gas and liquid. Standard commercial grade fuel cells then recombine the pure Hydrogen and Oxygen while producing electricity for the grid. Or the fuel may be used to power transportation devices, or it may be added to natural gas supplies to supplement industrial, commercial or residential heating.

What is claimed is:

1. The invention includes the use of a free floating or moored tank for the storage of hydrogen fuel or hydrogen laden solutions generated on or around the device.

2. The invention includes electro mechanical means of converting wave or wind energy at sea to electrical current, which in turn converts an aqueous solution into hydrogen and oxygen for storage and later transfer to energy use devices.

3. The device includes a mast attached to a semi-submerged tank rising above the surface to capture wind energy.

4. The invention may include underwater wings or propellers that rotate or flex as the device rides up and down on waves in order to capture wave energy.

5. The invention includes the system whereby Hydrogen produced by ocean wind or wave action captured at sea by a floating sea based device may be transferred to land for use as an energy source.
